(19) United States
(12) Patent Application Publication
(10) Pub. No.: US 2026/0169778 A1
(43) Pub. Date: Jun. 18, 2026

(54) SECURE VIRTUAL DEVICES FOR CONFIDENTIAL COMPUTING

(71) Applicant: Red Hat, Inc., Raleigh, NC (US)

(72) Inventor: Michael Tsirkin, Ra'anana (IL)

(21) Appl. No.: 18/980,040

(22) Filed: Dec. 13, 2024

(51) Int. Cl. G06F 9/455

(52) U.S. Cl. CPC G06F 9/45558; G06F 2009/45587

(57) ABSTRACT

Systems and methods are provided. An example method can include obtaining, by guest firmware executing in a virtual machine, data indicative of a first request for a virtual device to perform a first action, wherein the first request was generated by a guest operating system executing in the virtual machine. The example method can include providing, by the guest firmware to a physical hardware component of a physical computing device on which the virtual machine is executing, a second request for the physical hardware component to perform the first action. The example method can include receiving, by the guest firmware from the physical hardware component, a first response indicative of a first result of the first action. The example method can include providing, by the guest firmware to the guest operating system, a second response indicative of the first result of the first action.

### BACKGROUND

A virtual machine is a virtualization technology for emulating a physical computing system. A virtual machine typically runs a guest operating system in conjunction with a virtual machine monitor, such as a hypervisor, that is configured to coordinate access to physical resources of a “host” physical machine, such as a memory and a processor device, by one or more “guest” virtual machines running on the “host” physical machine.

### SUMMARY

The present disclosure is generally directed to systems and methods for emulating virtual devices using guest firmware executing in a virtual machine.

In one implementation, a method is provided. The method includes obtaining, by guest firmware executing in a virtual machine, data indicative of a first request for a virtual device to perform a first action, wherein the first request was generated by a guest operating system executing in the virtual machine. The method further includes providing, by the guest firmware to a physical hardware component of a physical computing device on which the virtual machine is executing, based at least in part on the first request, a second request for the physical hardware component to perform the first action. The method further includes receiving, by the guest firmware from the physical hardware component, a first response indicative of a first result of the first action. The method further includes providing, by the guest firmware to the guest operating system, based at least in part on the first response, a second response indicative of the first result of the first action.

In another implementation, a computing system is provided. The computing system includes one or more computing devices. The one or more computing devices are to obtain, by guest firmware executing in a virtual machine, a first request for a virtual device to perform a first action, wherein the first request was generated by a guest operating system executing in the virtual machine, wherein the virtual machine is executing on a first physical computing device of the one or more computing devices. The one or more computing devices are further to provide, by the guest firmware to a physical hardware component of the first physical computing device, based at least in part on the first request, a second request for the physical hardware component to perform the first action. The one or more computing devices are further to receive, by the guest firmware from the physical hardware component, a first response indicative of a first result of the first action. The one or more computing devices are further to provide, by the guest firmware to the guest operating system, based at least in part on the first response, a second response indicative of the first result of the first action.

In another implementation, a non-transitory computer-readable storage medium is provided. The non-transitory computer-readable storage medium includes executable instructions to cause a processor device to obtain, by guest firmware executing in a virtual machine, a first request for a virtual device to perform a first action, wherein the first request was generated by a guest operating system executing in the virtual machine, wherein the virtual machine is executing on a first physical computing device. The instructions further cause the processor device to provide, by the guest firmware to a physical hardware component of the first physical computing device, based at least in part on the first request, a second request for the physical hardware component to perform the first action. The instructions further cause the processor device to receive, by the guest firmware from the physical hardware component, a first response indicative of a first result of the first action. The instructions further cause the processor device to provide, by the guest firmware to the guest operating system, based at least in part on the first response, a second response indicative of the first result of the first action.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples disclosed herein may be practiced;

FIG. 2 is a sequence flow diagram of a method for providing a virtual device for a virtual machine;

FIG. 3 is a flowchart diagram of a method for providing a virtual device for a virtual machine;

FIG. 4 is a simplified block diagram of the environment illustrated in FIG. 1 according to one implementation; and

FIG. 5 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A virtual computing device (“virtual machine”) is a technology that runs on a physical computing device and performs computing operations. For example, a physical computing device may run multiple virtual machines, and a program called a hypervisor (also known as a virtual machine monitor) may coordinate usage of the physical machine’s computing resources (e.g., memory devices, processor devices, etc.) between multiple virtual machines. Each virtual machine may appear, from the point of view of an application running on the virtual machine, to be no different from a standalone physical computing device. Virtual machines may provide various advantages, such as allowing multiple users to run separate virtual machines on a single physical device.

However, allowing an untrusted hypervisor to oversee the operation of a virtual machine may pose a data security risk. For example, if a virtual machine performs operations on confidential data, a malicious hypervisor may attempt to access the confidential data while the virtual machine is running (e.g., by accessing computer memory).

One potential data security risk from a malicious hypervisor involves the emulation of virtual hardware devices, such as virtual input/output devices. A virtual hardware device is a technology for allowing multiple virtual machines to coordinate shared usage of a single hardware component (e.g., input/output component) of a physical computer. From the point of view of an application or operating system running in a virtual machine, the virtual device may appear to be no different from a physical hardware device. For example, in some instances, a virtual machine operating system (“guest” operating system) can be a standard operating system designed to run on a standalone physical computer, and the virtual machine operating system may attempt to interact with hardware devices in the same way it would on an ordinary physical computer. However, to enable interaction between a plurality of unmodified operating systems (sometimes referred to as a “legacy” operating systems) and a physical hardware device, a hypervisor can emulate a virtual device by intercepting the operating systems’ calls to the physical hardware device and coordinating the shared usage of the hardware device based on the intercepted calls.

However, many operating systems and device drivers have generally not been designed to interact with an untrusted hypervisor. Instead, some device drivers or operating systems may trust a hypervisor to act honestly and may not perform validation of data received from a hypervisor. This can create various security vulnerabilities that a malicious hypervisor may be able to exploit. For example, if a malicious hypervisor is trusted to emulate a peripheral component interconnect (PCI) device (a communication component for connecting other devices together), the malicious hypervisor can send a fraudulent device identifier to a guest operating system, which may cause the guest operating system to load an unnecessary device driver chosen by the malicious hypervisor, such as a device driver having a security vulnerability for the malicious hypervisor to exploit. As another example, a malicious hypervisor may send data indicating that a virtual device is hotplug-enabled to exploit various hotplug-related security vulnerabilities.

Advantageously, the examples set forth below provide various techniques that can protect confidential data from a malicious hypervisor, particularly in the context of emulating virtual devices. For example, a trusted “guest” firmware module can be loaded inside the virtual machine, and the guest firmware module can emulate a virtual device by intercepting hardware device calls from the guest operating system, and passing the device calls to a corresponding physical hardware device. In some examples, the guest firmware can perform validation on data received from the physical hardware device, thereby reducing a risk of security vulnerabilities. For example, validation can include comparing a device identifier to a list of trusted devices; editing a hotplug indicator to indicate that hotplug is disabled; or other validation techniques. In some implementations, the guest firmware can pass a device call directly to a hardware device without intervention from a hypervisor, thereby reducing a data security risk from a malicious hypervisor. Additionally, the examples set forth below provide other methods for securing confidential data, such as encrypting virtual memory inside the virtual machine; validating the guest firmware during bootup of the virtual machine; and other techniques.

The examples set forth below can provide a variety of technical effects and benefits, such as improved data security compared to some alternative implementations or reduced computational cost compared to some alternative implementations. For example, some examples set forth below can provide improved data security by emulating virtual devices without intervention from a hypervisor, thereby reducing a data security risk from a malicious hypervisor. As another example, some examples set forth below can provide improved data security by validating data received in response to device calls, thereby reducing various data security risks, such as data security risks associated with untrusted device drivers or data security risks associated with hotplug capabilities. As another example, some examples set forth below can provide improved data security at reduced computational cost compared to some alternative methods. For example, some examples set forth below can perform data validation in confidential computing cases, where data must be kept confidential from an untrusted hypervisor, and can avoid performing such validation in the non-confidential case where a hypervisor can be trusted with access to data inside the virtual machine. In this manner, for instance, improved security can be provided in the confidential case, without incurring additional computational overhead in the non-confidential case, thereby reducing a computational cost compared to some alternative methods that may behave identically in both the confidential and non-confidential cases.

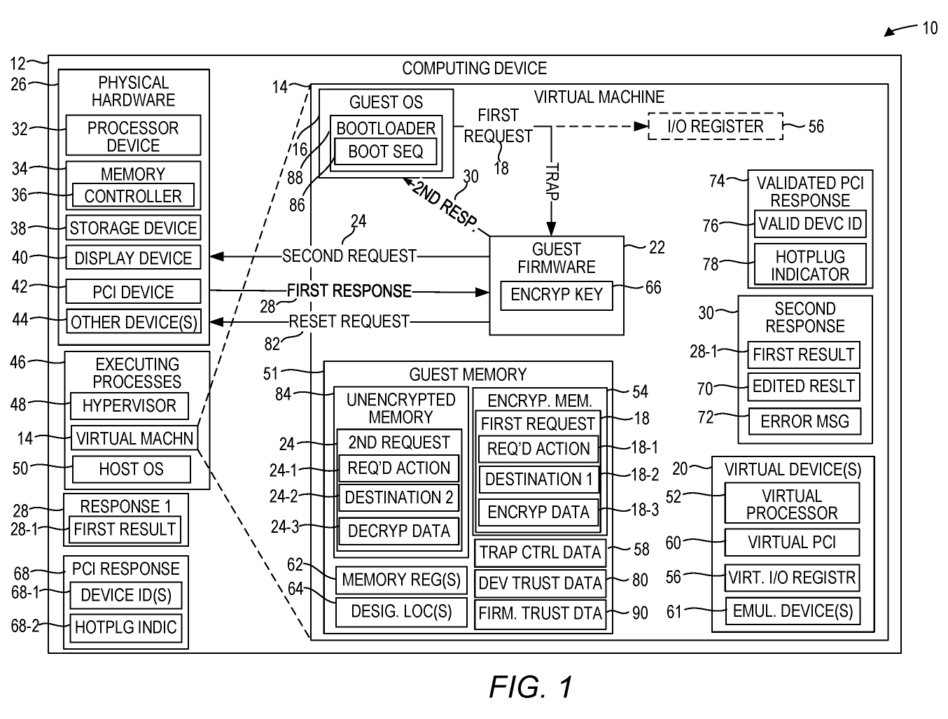

FIG. 1 is a block diagram of an environment in which examples disclosed herein may be practiced. A computing system 10 can include a computing device 12 with a virtual machine 14 executing on the computing device 12. A guest operating system 16 executing in the virtual machine 14 can send or attempt to send a first request 18 to a virtual device 20. Guest firmware 22 executing in the virtual machine 14 can intercept the first request 18, and can send a second request 24 to a physical hardware component 26 of the computing device 12 based on the first request 18. The guest firmware 22 can receive a first response 28 from the physical hardware component 26, and the guest firmware 22 can provide a second response 30 to the guest operating system 16 based at least in part on the first response 28.

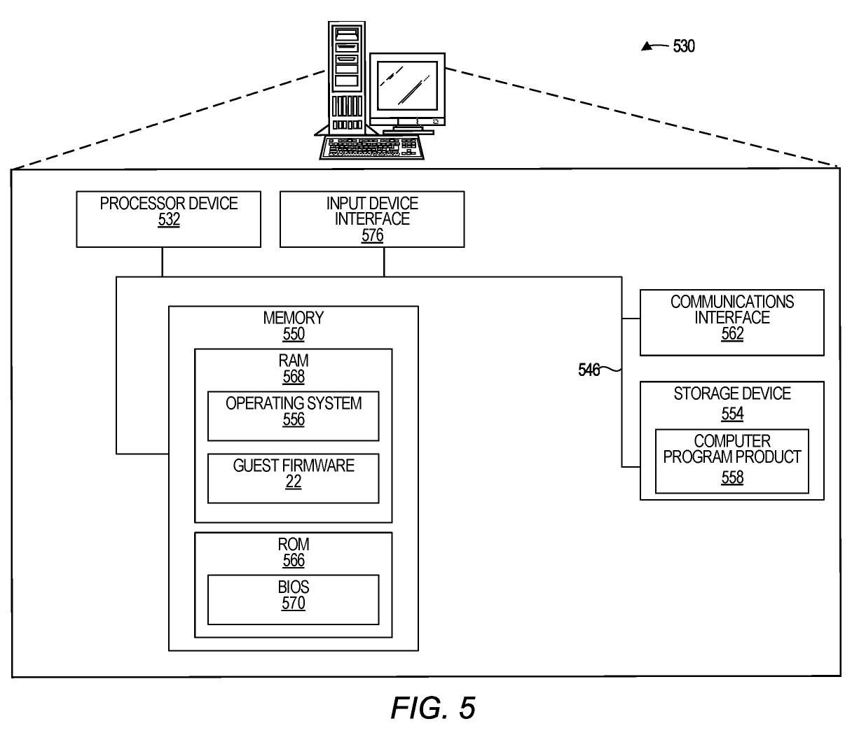

A computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing system 10 can include one or more processor devices 32, memories 34 comprising a memory controller 36, storage devices 38, or display devices 40. In some instances, a computing device 12 can include a physical peripheral component interconnect device 42 (PCI device) or other devices 44. The computing device 12 can execute one or more processes 46, such as a virtual machine 14, hypervisor 48, host OS 50, or other process. Additional example implementation details for a computing device 12 are provided below with respect to FIG. 5.

In some instances, a computing device 12 can include a computing device for hosting one or more virtual machines 14. In some instances, a computing device 12 can include a host operating system (OS) 50. In some instances, a hypervisor 48 can execute within the host OS 50. The hypervisor 48 (e.g., virtual machine monitor, virtualizer, etc.) can implement a virtualized environment via VM virtualization technology on the computing device 12. The hypervisor 48 can perform various functions, such as initializing, running, monitoring, configuring, overseeing, or otherwise managing one or more virtual machines (VMs) 14 operating within the host OS 50. As used herein, the terms “virtual machine monitor” and “hypervisor” can be considered interchangeable, and any action described as being performed by a hypervisor 48 can be performed by a virtual machine monitor and vice versa. A hypervisor can include, for example, a “bare metal” hypervisor running directly on native hardware; a “hosted” or “type 2” hypervisor (e.g., Quick Emulator (QEMU)) running on a host operating system (e.g., Red Hat Enterprise Linux, etc.); a kernel-based hypervisor module to cause a host operating system 50 to function as a hypervisor 48 (e.g., Kernel-based Virtual Machine (KVM) hypervisor); and the like.

A virtual machine 14 can include, for example, an executing process to emulate a computing system or device. A virtual machine 14 can, for example, run one or more processes (e.g., guest operating system processes, software application processes, etc.) using virtual hardware (e.g., virtual memory, virtual processor device, etc.) mapped to physical hardware of the computing device 12 (e.g., by a hypervisor 48, by guest firmware 22, etc.).

A guest operating system 16 or host operating system 50 can include one or more software, firmware, or hardware functions for managing computational resources (e.g., hardware resources, etc.) of a virtual machine 14 or computing device 12, respectively. In some instances, a guest OS 16 can belong to an OS family (e.g., Linux, Windows, iOS, Android, etc.) that is the same as or different from a host OS 50 operating on the same device. In some instances, a guest OS 16 can comprise an OS version (e.g., Red Hat Enterprise Linux 7, etc.) that is the same as or different from an OS version of a host OS 50 operating on the same device. A guest operating system 16 can be, for example, an operating system running within the virtual machine 14 (e.g., in an environment isolated from other virtual machines, etc.) overseeing functions associated only with the virtual machine 14. A host operating system 50 can be, for example, an operating system running outside a virtual machine 14, and may oversee functions associated with a computing device 12 that occur outside a virtual machine 14. As a non-limiting illustrative example, a computing device 12 may include a Red Hat Enterprise Linux 7 host operating system 50 overseeing functions associated with the physical computing resources of a computing device 12, and a virtual machine 14 executing on the computing device 12 (e.g., inside a VMM 48) can include a Red Hat Enterprise Linux 7 guest operating system 16 executing within the virtual machine 14 that is separate from the host operating system 50, and the guest operating system 16 can oversee functions associated with one or more virtual computing resources (e.g., virtual devices 20, guest memory 51, etc.) of the virtual machine 14. The virtual resources can include, for example, virtual resources that are assigned, allocated, or mapped to physical resources by a hypervisor 48.

In some instances, a guest operating system 16 can include an unmodified legacy operating system that was designed for use in a non-virtual (i.e., “bare metal”) computing device. For example, in some instances, the guest operating system 16 can interact with one or more virtual devices 20 by performing or requesting the same operations the guest OS 16 would perform or request when interacting with a physical hardware component 26 on a bare metal computing device; adhere to the same protocol or syntax; or otherwise behave in the same manner as a legacy operating system associated with a bare metal machine. For example, in some instances, the guest OS 16 can include a legacy operating system that is configured to interact with physical hardware components 26 (e.g., input/output components, etc.) by performing or attempting a write operation to write request data to a location (e.g., address, port, etc.) associated with a physical input/output (I/O) register (e.g., location where the physical I/O register would be on a bare metal machine). For example, in some instances, a guest OS 16 can interact with a virtual device 20 by writing or attempting to write a first request 18 to a location associated with such a physical I/O register. In some instances, the virtual machine 14 may lack a corresponding physical I/O register. In some instances, one or more other processes (e.g., guest firmware 22) or other components (e.g., processor device 32, virtual processor 52, etc.) can perform various actions, such as emulation of various virtual devices 20, to facilitate usage of such a legacy guest OS 16. Further details of some example device emulation actions are provided below.

As used herein, the term “input/output” can refer to input to or output from a virtual machine 14 or a component thereof (e.g., guest OS 16, virtual processing device 52, other virtual device 20, etc.), such as input/output communications between components of the virtual machine 14. For example, in some instances, an input/output device can include a device for communicating between components of a virtual machine 14 or computing device 12, such as a PCI device 42 for communicating between a guest operating system 16 or virtual processor 52 and other components (e.g., physical hardware components 26, virtual devices 20, etc.) of the same device 12, 14. The term “I/O register” can refer to a register used by one or more components of a computing device 12 or virtual machine 14 (e.g., guest OS 16, virtual processor 52, etc.) to perform input or output functions (e.g., input or output to a different component of the same computing device 12, input or output to a different computing device, etc.).

The first request 18 can include various data types, such as binary data (e.g., encrypted binary data, unencrypted binary data, etc.), computer code data (e.g., object code, machine code, assembly code, etc.), or other data types. In some instances, a first request 18 can include one or more parameters, such as parameters indicative of a requested action 18-1 associated with the first request 18, a parameter associated with a first destination 18-2 (e.g., location associated with a physical I/O register, location associated with a virtual device 20, etc.) for the first request 18, or other parameters. In some instances, a first request 18 can include encrypted data 18-3 or can be written to an encrypted memory region 54 of the virtual machine 14. In some instances, a first request 18 can include a request directed to a virtual device 20, such as a virtual device 20 emulated by the guest firmware 22 to provide functionality associated with a physical hardware component 26 of a bare metal computing device to the guest operating system 16. For example, in some instances, a first request 18 directed to a virtual device 20 can include a first request 18 that was generated by a legacy guest OS 16 and directed to a location associated with a physical hardware component 26 of a legacy computing device (e.g., “bare metal” machine), such as a location associated with a physical I/O register of a bare metal computing device.

In some instances, the guest firmware 22 or other components (e.g., processor device 32, virtual processor 52, etc.) can emulate a virtual device 20 by obtaining (e.g., receiving, intercepting, retrieving, etc.) a first request 18 and performing one or more operations to satisfy the first request 18. Operations to satisfy the first request can include, for example, generating a second request 24 directed to a physical hardware component 26 of the computing device 12, and providing a response associated with the second request 24 to the guest OS 16.

In some instances, obtaining a first request 18 can include intercepting (e.g., trapping, etc.) the first request 18. In some instances, intercepting a first request 18 can include trapping a write operation configured to write the first request 18 to one or more locations (e.g., physical or virtual register locations, physical or virtual memory locations, etc.). For example, in some instances, guest firmware 22 or one or more other components (e.g., processor device 32, virtual processor 52, etc.) or processes (e.g., hypervisor 48) can emulate a virtual I/O register 56 by trapping (e.g., intercepting, interrupting, transferring control of, etc.) write operations (e.g., operations to write a first request 18, etc.) directed to a location associated with an I/O register (e.g., virtual I/O register 56, physical I/O register location associated with a bare metal machine, etc.) and implementing substitute operations. Trapping an operation can include, for example, interrupting the operation (e.g., throwing an exception without performing the operation, etc.). In some instances, trapping an operation can further include transferring control (e.g., control of the operation, control of the virtual processor 52 or other computing resource, etc.) to another process different from the guest operating system 16, such as the guest firmware 22. For example, a virtual processor 52 can interrupt (e.g., by throwing an exception, etc.) a write operation associated with a first request 18 and can transfer control to the guest firmware 22 (e.g., by providing the guest firmware 22 with data indicative of an exception, etc.).

In some instances, trapping can be based at least in part on a trap control data structure 58. For example, in some instances, a trap control data structure 58 can store authorization data indicative of one or more operations or categories of operations that the guest OS 16 is authorized or not authorized to perform. Example operations that may be unauthorized can include read-write operations directed to a particular location or range of locations (e.g., memory address range, register location range, etc.); low-level read-write operations in general; calls to virtual devices 20 in general or categories thereof (e.g., virtual PCI devices 60, other emulated devices 61, etc.); or other operations categories. For example, in some instances, a trap control data structure 58 can store authorization data indicating that the guest OS 16 is not permitted to write to one or more locations associated with one or more I/O registers (e.g., virtual I/O register 56 locations, physical I/O register locations associated with a bare metal machine, etc.). In some instances, a process or component within the virtual machine 14 (e.g., virtual processor 52, guest firmware 22) can trap an operation that the virtual machine 14 would not be authorized to perform (e.g., operation that would be trapped by a hypervisor 48 if the virtual machine 14 attempted to perform it) and perform one or more substitute operations that the virtual machine 14 is authorized to perform (e.g., substitute operations that will not be trapped by a hypervisor 48, etc.).

A virtual device 20 can include, for example, one or more software, firmware, or hardware components to provide functionality of one or more physical hardware components 26 to the guest operating system 16, virtual machine 14, or other process executing within the virtual machine 14. In some instances, a virtual device 20 can include a virtual device 20 that is emulated by the guest firmware 22, such as guest firmware 22 operations to intercept (e.g., trap, etc.) a first request 18 and perform operations to satisfy the first request 18 (e.g., sending a second request 24 to a physical hardware component; receiving a first response 28 from the physical hardware component 26 and providing a corresponding second response 30 to the guest OS 16; etc.).

In some instances, a virtual device 20 can include a virtual peripheral component interconnect device (virtual PCI device) 60. A virtual PCI device 60 can include, for example, a virtual device 20 to provide PCI functionality to the guest OS 16 or other processes executing in the virtual machine 14. In some instances, a virtual PCI device 60 can include a virtual device 20 that operates according to a PCI communication protocol (e.g., PCI Express protocol, etc.).

Guest firmware 22 can include, for example, one or more software, firmware, or hardware components to provide low-level control of one or more virtual machine 14 functions (e.g., virtual device 20 functions, etc.) and to provide an interface between a guest operating system 16 and one or more virtual devices 20. In some instances, the guest firmware 22 can include an executing process executing inside the virtual machine 14.

A second request 24 can include various data types, such as binary data (e.g., encrypted binary data, unencrypted binary data, etc.), computer code data (e.g., object code, machine code, assembly code, etc.), or other data types. In some instances, a second request 24 can include one or more parameters, such as parameters indicative of a requested action 24-1 associated with the second request 24, a parameter associated with a second destination 24-2 for the second request 24, or other parameters. In some instances, a second request 24 can include unencrypted data (e.g., decrypted data 24-3, etc.) or can be written to an unencrypted memory region 84 of the virtual machine 14. In some instances, a second request 24 can include a request directed to a physical hardware component 26, such as a request provided directly to a physical hardware component 26 without intervention from a hypervisor 48.

In some instances, a requested action 24-1 associated with a second request 24 can be similar to (e.g., same as, equivalent to, analogous to, etc.) a corresponding requested action 18-1 of a first request 18. As a non-limiting illustrative example, if a first request 18 includes a request for a virtual PCI device 60 to provide data indicative of a PCI topology associated with the virtual PCI device 60, a second request 24 can include a request for a physical PCI device 42 to provide data indicative of a PCI topology associated with the physical PCI device 42.

In some instances, a second destination 24-2 associated with the second request 24 can be different from a first destination 18-2 associated with the first request. For example, in some instances, a first destination 18-2 can include a legacy destination (e.g., legacy I/O register address, etc.) that a legacy operating system would use to interact with a physical hardware component 26 on a bare-metal machine. In some instances, a second destination 24-2 can include a destination for accessing a corresponding physical hardware component 26 of the computing device 12 from inside the virtual machine 14. For example, in some instances, guest firmware 22 can provide a second request 24 to a physical hardware component 26 by writing the second request 24 to a memory register 62 associated with the physical hardware component 26 (e.g., without intervention from a hypervisor 48), or by otherwise sending the second request 24 to a designated location 64 (e.g., designated memory location, etc.) for sending requests directed to the physical hardware component 26.

In some instances, a second request 24 can include unencrypted data, such as decrypted data 24-3 that has been decrypted based on encrypted data 18-3 of the first request 18. For example, in some instances, a virtual machine 14 can perform one or more confidential computing operations by encrypting a portion of its memory using an encryption key 66, such as an encryption key 66 that one or more components outside the virtual machine 14 (e.g., physical hardware components 26, hypervisor 48, host OS 50, etc.) may not have access to. In such instances, the guest operating system 16 may be configured to write the first request 18 to encrypted memory 54. In some instances, the guest firmware 22 can decrypt all or part of the first request 18 and provide an unencrypted second request 24 to a physical hardware component 26 (e.g., by writing the second request 24 to unencrypted memory 84 of the virtual machine 14, etc.). Further details of an example virtual machine boot sequence comprising memory encryption operations are provided below.

Guest firmware 22 can generate the second request 24 based at least in part on the first request 18, and can provide the second request 24 to the physical hardware component 26. Providing the second request 24 can include, for example, identifying a first destination 18-2 associated with the first request 18; mapping the first destination 18-2 to a corresponding second destination 24-2; and providing (e.g., writing, transmitting, etc.) the second request 24 to the second destination 24-2 (e.g., memory register 62, other designated location 64, etc.). In some instances, mapping a first destination 18-2 to a second destination 24-2 can include retrieving, from a data structure correlating request destinations associated with a legacy operating system to corresponding request destinations associated with one or more physical hardware components 26 of the computing device 12, a data entry correlating the first destination 18-2 with the second destination 24-2. In some instances, generating the second request 24 based on the first request 18 can include mapping a first requested action 18-1 to a corresponding second requested action 24-1. In some instances, mapping a requested action can include retrieving, from a mapping data structure correlating legacy requested actions associated with a legacy operating system to corresponding requested actions 24-1 associated with a physical hardware component 26, a data entry mapping the first requested action 18-1 to the second requested action 24-1. In some instances, generating the second request 24 can include decrypting all or part of the first request 18 (e.g., encrypted data 18-3) before generating the second request 24 based at least in part on the decrypted data 24-3.

A physical hardware component 26 can include, for example, any hardware component of a computing device 12, such as processors 32, memory 34, storage devices 38, display devices 40, PCI devices 42, or other devices 44. In some instances, a physical hardware component 26 can include one or more input/output hardware devices, such as a PCI device 42.

A first response 28 can include, for example, any data (e.g., binary data, text data, numerical data, encrypted data, unencrypted data, etc.) received (e.g., by guest firmware 22) from a physical hardware component 26 in response to a second request 24. In some instances, a first response 28 can include first result data 28-1 indicative of a result of an action taken by the physical hardware component 26 in response to the second request 24 (e.g., according to a requested action 24-1). In some instances, a first response 28 can include a PCI response 68 that is formatted according to a PCI communication protocol. For example, in some instances, a PCI response 68 can include one or more device identifiers 68-1 (e.g., PCI topology data comprising one or more device identifiers 68-1, etc.); a hot plug indicator 68-2; or other data. A hot plug indicator can include, for example, an indicator (e.g., bit, register, etc.) indicating whether or not a physical hardware component 26 (e.g., PCI device 42, physical hardware component 26 connected to a PCI device 42, etc.) or virtual device 20 is compatible with hot plugging (sometimes referred to as “hot swapping”). As used herein, hot plugging can refer to connecting, disconnecting, installing, uninstalling, swapping (e.g., replacing, substituting, etc.), or the like during operation of a virtual machine 14 or computing device 12 (e.g., without restarting the computing device 12 or virtual machine 14). PCI topology data can include, for example, data indicative of one or more devices that are connected to a PCI device 42, such as device identifiers; locations of connected devices; or other data for interacting with devices connected to the PCI device 42.

A second response 30 can include, for example, data (e.g., binary data, text data, numerical data, encrypted data, unencrypted data, etc.) provided by the guest firmware 22 to the guest OS 16 based on a first response 28. In some instances, a second response 30 can include first result data 28-1 or other result data (e.g., edited result data 70, error message data 72, second result data based on the first result data, etc.) indicative of a result of an action taken by the physical hardware component 26 in response to the second request 24.

In some instances, a second response 30 can include a validated PCI response 74 that has been validated by the guest firmware 22. A validated PCI response 74 can include, for example, one or more valid device identifiers 76 (e.g., PCI topology data comprising one or more valid device identifiers 76); one or more hotplug indicators 78; or other data.

In some instances, a valid device identifier 76 can include a device identifier 68-1 that has been validated by the guest firmware 22. Validating a device identifier 68-1 can include, for example, determining that the device identifier 68-1 is associated with one or more trusted devices or device drivers; devices or device drivers that are authorized to execute inside the virtual machine 14; or the like. In some instances, validating a device identifier 68-1 contained in a first response 28 can include comparing the device identifier 68-1 to a data structure (e.g., list, database, table, etc.) comprising one or more data entries indicative of one or more devices (e.g., virtual devices 20, physical hardware components 26, etc.) or corresponding device drivers that are authorized for use in the virtual machine 14 (e.g., device drivers that are authorized to be loaded by the guest OS 16, etc.). For example, in some instances, validating a device identifier 68-1 can include retrieving, from a trusted device data structure 80 based on the device identifier 68-1, a data record associated with the device identifier 68-1; and determining, based on the data record, whether the device identifier 68-1 is associated with a trusted device or trusted device driver. In some instances, guest firmware 22 can receive, from a physical hardware component 26 (e.g., PCI device 42), a first response 28 (e.g., PCI response 68) comprising a plurality of device identifiers 68-1; validate each device identifier 68-1 of the plurality of device identifiers 68-1; and provide, to the guest operating system 16, a second response 30 (e.g., validated PCI response 74) comprising valid device identifiers 76 of the plurality of device identifiers 68-1, wherein the second response 30 omits any invalid device identifiers 68-1 of the first response 28.

In some instances, a hotplug indicator 78 of a second response 30 (e.g., validated PCI response 74) can be set to indicate that any device associated with the second response is not hotplug-enabled (e.g., not hotplug-capable, etc.). For example, in some instances, a hotplug indicator 68-2 of a first response 28 can be ignored, and hotplug indicator 78 of a second response 30 can be set to “disabled” irrespective of the hotplug indicator 68-2 of the first response.

In some instances, guest firmware 22 can validate a first response 28 and can perform, responsive to determining that all or part of the first response 28 is invalid, one or more corrective actions. A corrective action can include, for example, editing all or part of the first response 28 to generate a valid second response 30; sending a reset request 82 to a physical hardware component 26 and then resending a second request 24; or providing an error message 72 to the guest OS 16 or other process or component of the virtual machine 14. An error message 72 can include, for example, any data (e.g., binary data, text data, error code data, exception data, etc.) indicative of a validation error associated with the first response 28. Editing a first response 28 can include, for example, deleting, replacing, or otherwise editing one or more parts of the first response 28 that are determined to be invalid. As a non-limiting illustrative example, editing a first response 28 can include deleting one or more invalid device identifiers 68-1 or other invalid response data.

In some instances, validating a first response 28 can include applying one or more validation rules to the first response 28. Validation rules can include, for example, formatting rules, length restrictions, content restrictions, or other rules distinguishing invalid first responses 28 from valid first responses 28.

In some instances, a virtual machine 14 can be configured to use encrypted memory 54 to protect data stored in encrypted memory 54 from unauthorized access (e.g., unauthorized access by a hypervisor 48, host OS 50, other virtual machines, or other processes executing outside the virtual machine 14). In some instances, guest firmware 22 can be configured to initialize encrypted memory 54 and unencrypted memory 84 during a boot sequence 86 of the virtual machine 14. For example, in some instances, a hypervisor 48 can initialize a virtual machine 14. Initializing the virtual machine can include, for example, initializing a bootloader 88 associated with the guest operating system 16 to boot the virtual machine 14. Upon initialization, the bootloader 88 can execute a boot sequence 86 to boot the virtual machine 14.

A boot sequence 86 can include, for example, initializing the guest firmware 22. In some instances, the bootloader 88 can validate the guest firmware 22 before initializing it. For example, in some instances, the bootloader 88 can validate the guest firmware 22 by comparing data (e.g., hash data, etc.) indicative of the guest firmware 22 to data (e.g., hash data, etc.) indicative of one or more trusted firmware modules. For example, in some instances, the bootloader 88 can generate or otherwise obtain a hash (e.g., cryptographic hash, etc.) associated with the guest firmware 22 (e.g., hash of binary object code associated with the guest firmware 22, etc.) and can compare the hash to a trusted firmware data structure 90 comprising hash data indicative of one or more trusted firmware modules. For example, in some instances, the guest bootloader 88 can retrieve, based at least in part on a hash associated with the guest firmware 22, from a hash table comprising hash data of one or more trusted firmware modules, a data entry associated with the hash. In some instances, the guest bootloader 88 can, responsive to retrieving a data entry indicating that a hash of the guest firmware 22 corresponds to a hash of a trusted firmware module, initialize the guest firmware 22. In some instances, the guest bootloader 88 can, responsive to determining that a hash of the guest firmware 22 does not correspond to a trusted hash value, perform one or more alternative actions, such as shutting down the virtual machine 14; sending an error message; booting the virtual machine 14 without loading the guest firmware 22; or other corrective action.

In some instances, the guest firmware 22 can initialize, during a bootup process of the virtual machine 14 (e.g., subsequent to being initialized by the guest bootloader 88, etc.), one or more encrypted memory regions 54 and one or more unencrypted memory regions 84. For example, in some instances, the guest firmware 22 can initialize an exclusion range indicative of a plurality of memory locations (e.g., addresses, registers, etc.) that a guest OS 16 is prohibited from writing data to. In some instances, the exclusion range can correspond to all or part of an unencrypted memory region 84. Initializing an exclusion range can include, for example, writing data indicative of the exclusion range to an exclusion range register. In some instances, the guest firmware 22 can further initialize an encrypted memory region 54. Initializing an encrypted memory region 54 can include, for example, writing memory location data (e.g., address ranges, etc.) defining the memory region 54 to a memory range register; encrypting all or part of the encrypted memory region 54; or other initialization action. In some instances, an encrypted memory region 54 can be encrypted according to an ephemeral encryption key, such as a temporary encryption key 66 generated by a processor device 32 (e.g., processor device 32 associated with trusted execution environment hardware). In some instances, an encryption key 66 (e.g., ephemeral encryption key, etc.) can be shared with one or more processes inside the virtual machine 14 (e.g., guest OS 16, guest firmware 22, etc.) and not shared with one or more processes executing outside the virtual machine 14 (e.g., hypervisor 48, host OS 50, etc.).

Because the virtual machine 14, guest OS 16, virtual devices 20, guest firmware 22, hypervisor 48, and host OS 50 are components of the computing device 12, functionality implemented by the virtual machine 14, guest OS 16, virtual devices 20, guest firmware 22, hypervisor 48, or host OS 50 may be attributed to the computing device 12 generally. Moreover, in examples where the virtual machine 14, guest OS 16, virtual devices 20, guest firmware 22, hypervisor 48, or host OS 50 comprise a processor device 32 to carry out functionality discussed herein, functionality implemented by the virtual machine 14, guest OS 16, virtual devices 20, guest firmware 22, hypervisor 48, or host OS 50 may be attributed herein to the processor device 32.

It is further noted that while various components, such as the hypervisor 48 and host OS 50, are shown as separate components, in other implementations, the same functionality may be implemented in a different number of components. As an illustrative example, the hypervisor 48 and host OS 50 could be implemented in a single component or could be implemented in a greater number of components than two.

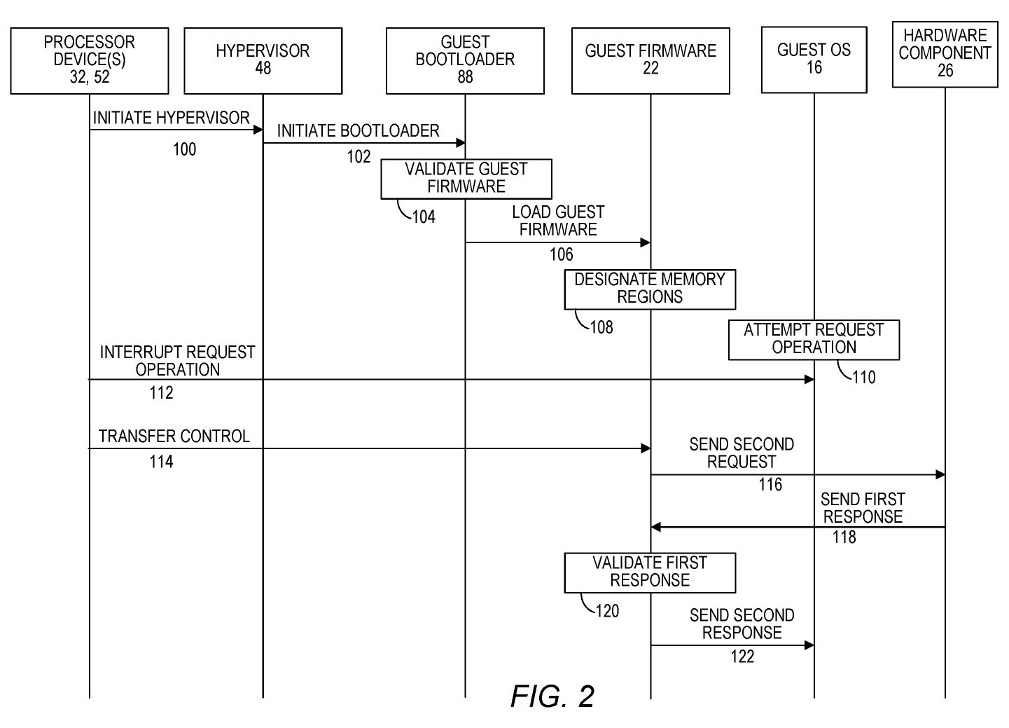

FIG. 2 is a sequence flow diagram of a method for providing a virtual device for a virtual machine. At 100 to 108, the processor device(s) 32, 52, hypervisor 48, guest bootloader 88, and guest firmware 22 can work together to initialize a confidential computing environment in a virtual machine 14. At 110 to 122, the guest firmware 22 can intercept a request from the guest OS 16 to a virtual device 20, and the guest firmware 22 can emulate the virtual device 20 using the hardware component 26.

At 100, a physical processor device 32 can initiate a hypervisor 48. At 102, the hypervisor 48 can initiate the guest bootloader 88.

At 104, the guest bootloader 88 can validate the guest firmware 22. For example, in some instances, the guest bootloader 88 can compare data (e.g., hash data) indicative of the guest firmware 22 to data (e.g., hash data such as hash table data, etc.) indicative of one or more trusted firmware modules. For example, the guest bootloader 88 can generate a hash of binary code of the guest firmware 22 to generate a hash value, and compare the hash value to one or more hash values associated with one or more trusted firmware modules.

At 106, the guest bootloader can load (e.g. initialize, initiate, etc.), responsive to determining that the guest firmware 22 is valid, the guest firmware 22.

At 108, the guest firmware 22 can initialize one or more encrypted or unencrypted memory regions 54, 84. For example, the guest firmware 22 can initialize one or more memory range registers defining the encrypted or unencrypted memory regions 54, 84; encrypt data in the encrypted memory regions 54; or perform one or more other initialization actions.

At 110, the guest OS 16 can send or attempt to send a request to a virtual device 20 to cause the virtual device 20 to perform a first action. For example, in some instances, a legacy guest OS 16 can attempt to write a first request 18 to a virtual I/O register 56. Other implementations are possible.

At 112, a processor device 32, 52 can interrupt the request operation. For example, in some instances, a virtual processor device 52 can determine, based on a trap control data structure 58, that the guest OS 16 is not authorized to perform a write operation associated with the first request 18 and can interrupt the write operation responsive to the determination.

At 114, the processor device 32, 52 can transfer control to the firmware. For example, in some instances, the processor device 52 can throw an exception responsive to determining that the guest OS 16 is not authorized to perform an operation, and can transfer control to the guest firmware 22 for exception handling. Other implementations are possible.

At 116, the guest firmware 22 can send a second request 24 to a hardware component 26 to cause the hardware component 26 to perform the first action requested by the guest OS 16. For example, the guest firmware 22 can identify a first destination 18-2 (e.g., intended destination device, virtual device 20, virtual I/O register 56, etc.) associated with the first request 18; map the first destination 18-2 to a corresponding second destination 24-2 (e.g., corresponding true destination device, physical hardware component 26, memory register 62, designated location 64, etc.); and provide (e.g., write, transmit, etc.) a second request 24 to the second destination 24-2. In some instances, the second request 24 can include data indicative of a requested action 24-1 that is the same as or otherwise analogous to a requested action 18-1 associated with the first request 18.

At 118, the hardware component 26 can perform the requested action and send a first response 28 to the guest firmware 22 based on the performed action.

At 120, the guest firmware 22 can validate the first response 28. For example, the guest firmware 22 can compare the first response 28 to one or more validation rules or validation data structures, such as trusted device data structures 80. For example, in some instances, the guest firmware 22 can compare one or more device identifiers 68-1 of a first response 28 to one or more device identifiers retrieved from a trusted device data structure 80. The guest firmware 22 can determine, based on the comparison, whether the device identifiers 68-1 are valid.

At 122, the guest firmware 22 can send a second response 30 to the guest OS 16. The second response 30 can include, for example, edited or unedited data indicative of a first result 28-1 of the requested action performed by the physical hardware component 26. For example, in some instances, the guest firmware 22 can validate the first response 28 and can provide, responsive to a determination that the first response 28 is valid, unmodified first result data 28-1 to the guest OS 16. As another example, the guest firmware 22 can provide, responsive to a determination that all or part of a first response 28 is invalid, an error message 72; edited result data 70; or other data.

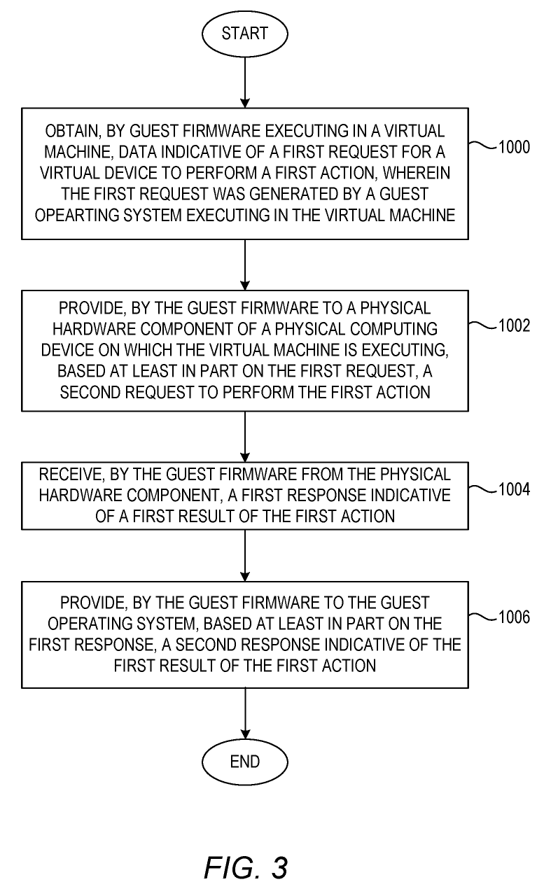

FIG. 3 is a flowchart diagram of a method for providing a virtual device for a virtual machine. Although FIG. 3 depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

At 1000, the method of FIG. 3 can include obtaining, by guest firmware (e.g., guest firmware 22) executing in a virtual machine (e.g., virtual machine 14), data indicative of a first request (e.g., first request 18) for a virtual device (e.g., virtual device 20) to perform a first action (e.g., requested action 18-1), wherein the first request was generated by a guest operating system (e.g., guest operating system 16) executing in the virtual machine. In some instances, the method of FIG. 3 can include, at 1000, performing one or more operations or using one or more components described above with respect to FIG. 1 or FIG. 2.

At 1002, the method of FIG. 3 can include providing, by the guest firmware to a physical hardware component (e.g., physical hardware component 26, PCI device 42, etc.) of a physical computing device (e.g., computing device 12) on which the virtual machine is executing, based at least in part on the first request, a second request (e.g., second request 24) for the physical hardware component to perform the first action. In some instances, the method of FIG. 3 can include, at 1000, performing one or more operations or using one or more components described above with respect to FIG. 1 or FIG. 2.

At 1004, the method of FIG. 3 can include receiving, by the guest firmware from the physical hardware component, a first response (e.g., first response 28) indicative of a first result (e.g., first result 28-1) of the first action. In some instances, the method of FIG. 3 can include, at 1000, performing one or more operations or using one or more components described above with respect to FIG. 1 or FIG. 2.

At 1006, the method of FIG. 3 can include providing, by the guest firmware to the guest operating system, based at least in part on the first response, a second response (e.g., second response 30) indicative of the first result of the first action. In some instances, the method of FIG. 3 can include, at 1000, performing one or more operations or using one or more components described above with respect to FIG. 1 or FIG. 2.

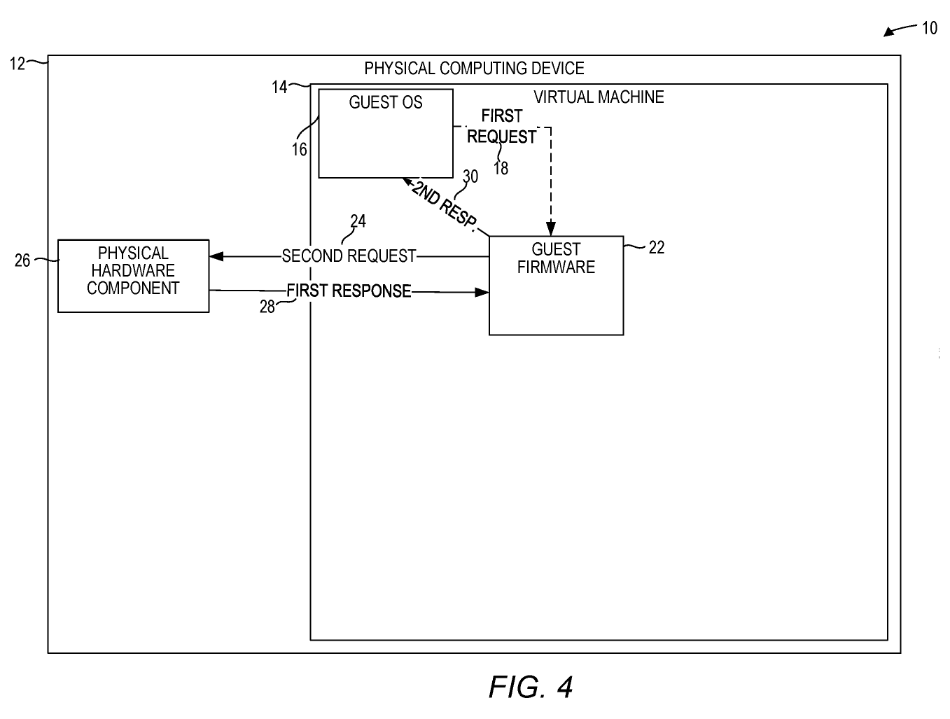

FIG. 4 is a simplified block diagram of the environment illustrated in FIG. 1 according to one implementation. Guest firmware 22 executing in a virtual machine 14 can obtain data indicative of a first request 18 for a virtual device to perform a first action, wherein the first request 18 was generated by a guest operating system 16 executing in the virtual machine. The guest firmware 22 can provide, to a physical hardware component 26 of a physical computing device 12 on which the virtual machine 14 is executing, a second request 24 for the physical hardware component 26 to perform the first action. The guest firmware 22 can receive, from the physical hardware component 26, a first response 28 indicative of a first result of the first action. The guest firmware 22 can provide, to the guest operating system 16, a second response 30 indicative of the first result of the first action.

FIG. 5 is a block diagram of a computing device 530 suitable for implementing examples according to one example. The computing device 530 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 530 includes the processor device 532, the system memory 550, and a system bus 546. The system bus 546 provides an interface for system components including, but not limited to, the system memory 550 and the processor device 532. The processor device 532 can be any commercially available or proprietary processor.

The system bus 546 may be any of several types of bus structures that may further interconnect to a memory bus (with or without a memory controller), a peripheral bus, and/or a local bus using any of a variety of commercially available bus architectures. The system memory 550 may include non-volatile memory 566 (e.g., read-only memory (ROM), erasable programmable read-only memory (EPROM), electrically erasable programmable read-only memory (EEPROM), etc.), and volatile memory 568 (e.g., random-access memory (RAM)). A basic input/output system (BIOS) 570 may be stored in the non-volatile memory 566 and can include the basic routines that help to transfer information between elements within the computing device 530. The volatile memory 568 may also include a high-speed RAM, such as static RAM, for caching data.

The computing device 530 may further include or be coupled to a non-transitory computer-readable storage medium such as the storage device 554, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 554 and other drives associated with computer-readable media and computer-usable media may provide non-volatile storage of data, data structures, computer-executable instructions, and the like.

A number of modules can be stored in the storage device 554 and in the volatile memory 568, including an operating system 556 and one or more program modules, such as the guest firmware 22, which may implement the functionality described herein in whole or in part. All or a portion of the examples may be implemented as a computer program product 558 stored on a transitory or non-transitory computer-usable or computer-readable storage medium, such as the storage device 554, which includes complex programming instructions, such as complex computer-readable program code, to cause the processor device 532 to carry out the steps described herein. Thus, the computer-readable program code can comprise software instructions for implementing the functionality of the examples described herein when executed on the processor device 532. The processor device 532, in conjunction with the guest firmware 22 in the volatile memory 568, may serve as a controller, or control system, for the computing device 530 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 532 through an input device interface 576 that is coupled to the system bus 546 but can be connected by other interfaces such as a parallel port, an Institute of Electrical and Electronic Engineers (IEEE) 1394 serial port, a Universal Serial Bus (USB) port, an IR interface, and the like. The computing device 530 may also include the communications interface 562, such as an Ethernet transceiver and/or a Wi-Fi transceiver, or the like, suitable for communicating with the network as appropriate or desired. The computing device 530 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by guest firmware executing in a virtual machine, data indicative of a first request for a virtual device to perform a first action, wherein the first request was generated by a guest operating system executing in the virtual machine;
providing, by the guest firmware to a physical hardware component of a physical computing device on which the virtual machine is executing, based at least in part on the first request, a second request for the physical hardware component to perform the first action;
receiving, by the guest firmware from the physical hardware component, a first response indicative of a first result of the first action; and
providing, by the guest firmware to the guest operating system, based at least in part on the first response, a second response indicative of the first result of the first action.

2. The method of claim 1, wherein obtaining the data indicative of the first request comprises:
interrupting, by the physical computing device, a first operation of the guest operating system, wherein the first operation comprises an operation to write request data associated with the first request to a register; and
transferring, by the physical computing device, control of the virtual machine to the guest firmware.

3. The method of claim 2, wherein the register is an input/output register.

4. The method of claim 1, wherein providing the second request comprises writing the second request to a designated memory location that is designated for writing requests directed to the physical hardware component.

5. The method of claim 1, wherein providing the second request comprises providing the second request directly to the physical hardware component, without intervention from a hypervisor executing on the physical computing device.

6. The method of claim 1, further comprising validating, by the guest firmware prior to providing the second response to the guest operating system, the first response.

7. The method of claim 6, wherein validating the first response comprises:
identifying, by the guest firmware, a first device identifier contained in the first response; and
comparing, by the guest firmware, the first device identifier to one or more second device identifiers, wherein the one or more second device identifiers are indicative of one or more trusted devices.

8. The method of claim 6, further comprising:
determining, by the guest firmware, that the first response is an invalid response; and
performing, by the guest firmware, a corrective action comprising one or more of:
providing, by the guest firmware to the guest operating system, an error message;
providing, by the guest firmware to the physical computing device, a request to reset the physical hardware component; and
editing, by the guest firmware, the first response to generate a valid response.

9. The method of claim 1, further comprising:
encrypting, by the virtual machine during a boot sequence of the virtual machine based on an encryption key, at least a portion of guest memory of the virtual machine.

10. The method of claim 9, wherein the first request comprises encrypted data that has been encrypted according to the encryption key, and further comprising:
decrypting, by the guest firmware, the encrypted data to generate decrypted data; and
including, by the guest firmware, at least a portion of the decrypted data in the second request.

11. The method of claim 1, further comprising:
initiating, by the physical computing device, a boot sequence for the virtual machine; and
initiating, by the physical computing device during the boot sequence, the guest firmware.

12. The method of claim 11, further comprising:
comparing, by the physical computing device, first data associated with the guest firmware to second data associated with one or more trusted firmware modules; and
determining, by the physical computing device based on comparing the first data to the second data, that the one or more trusted firmware modules comprise the guest firmware;
wherein the guest firmware is initiated responsive to determining that the one or more trusted firmware modules comprise the guest firmware.

13. The method of claim 1, further comprising:
identifying, by the guest firmware based on the first request, an intended destination device to which the first request is directed; and
mapping, by the guest firmware, the intended destination device to a corresponding true destination device;
wherein the corresponding true destination device is the physical hardware component.

14. The method of claim 1, wherein the first response comprises data indicating that the physical hardware component is hotplug-capable, and further comprising:
modifying, by the guest firmware, the second response to indicate that the virtual device is not hotplug-capable.

15. The method of claim 1, wherein the physical hardware component comprises a peripheral component interconnect device.

16. A computing system comprising:
one or more computing devices to:
obtain, by guest firmware executing in a virtual machine, data indicative of a first request for a virtual device to perform a first action, wherein the first request was generated by a guest operating system executing in the virtual machine, wherein the virtual machine is executing on a first physical computing device of the one or more computing devices;
provide, by the guest firmware to a physical hardware component of the first physical computing device, based at least in part on the first request, a second request for the physical hardware component to perform the first action;
receive, by the guest firmware from the physical hardware component, a first response indicative of a first result of the first action; and
provide, by the guest firmware to the guest operating system, based at least in part on the first response, a second response indicative of the first result of the first action.

17. The computing system of claim 16, wherein the one or more computing devices are further to:
validate, by the guest firmware prior to providing the second response to the guest operating system, the first response.

18. The computing system of claim 16, wherein the one or more computing devices are further to:
encrypt, by the virtual machine during a boot sequence of the virtual machine based on an encryption key, at least a portion of guest memory of the virtual machine.

19. The computing system of claim 16, wherein the physical hardware component comprises a peripheral component interconnect device.

20. A non-transitory computer-readable storage medium that includes executable instructions to cause one or more processor devices to:
obtain, by guest firmware executing in a virtual machine, data indicative of a first request for a virtual device to perform a first action, wherein the first request was generated by a guest operating system executing in the virtual machine;
provide, by the guest firmware to a physical hardware component of a physical computing device on which the virtual machine is running, based at least in part on the first request, a second request for the physical hardware component to perform the first action;
receive, by the guest firmware from the physical hardware component, a first response indicative of a first result of the first action; and
provide, by the guest firmware to the guest operating system, based at least in part on the first response, a second response indicative of the first result of the first action.
